(19) United States
(12) Patent Application Publication
(10) Pub. No.: US 2026/0148397 A1
(43) Pub. Date: May 28, 2026

(54) INFRASTRUCTURE AND TECHNIQUES FOR VEHICLE MONO CAMERA BASED DEPTH PERCEPTION AND AUTOMATED VEHICLE PARKING

(71) Applicant: FCA US LLC, Auburn Hills, MI (US)

(72) Inventors: Daniel Cashen, Auburn Hills, MI (US); Emily A Robb, Auburn Hills, MI (US)

(21) Appl. No.: 18/958,199

(22) Filed: Nov. 25, 2024

(51) Int. Cl. G06T 7/50; B60W 30/06; G06V 10/44; G06V 20/58

(52) U.S. Cl. CPC G06T 7/50; B60W 30/06; G06V 10/44; G06V 20/586; B60W 2420/403; B60W 2552/53; G06T 2207/10028; G06T 2207/30256

(57) ABSTRACT

A mono camera based depth perception system for a vehicle includes a mono camera system configured to capture image data of an environment external to the vehicle, the environment including a set of markings that are recognizable by the mono camera system and a control system configured to determine depth from the mono camera system or the vehicle to the set of markings based on the captured image data and known parameters of the set of markings, localize a position of the vehicle within the environment based on the determined depth, and control operation of the vehicle based on its localized position within the environment.

### FIELD

The present application generally relates to vehicle perception systems and, more particularly, to an infrastructure and techniques for vehicle mono camera based depth perception and automated vehicle parking.

### BACKGROUND

Vehicle perception systems use depth data to build an environmental model (i.e., of the area surrounding the vehicle) and to localize the position of the vehicle relative to a high-definition (HD) map. Camera-based depth perception is an estimate (not a direct measurement) and thus is typically inaccurate, particularly for mono (monocular) cameras. Higher end vehicles therefore typically add light detection and ranging (LIDAR) for precise depth perception and vehicle localization, but LIDAR is very expensive. Radio detection and ranging (RADAR) systems could also be added and utilized, but these also increase costs and do not perform as well as LIDAR. Thus, fully autonomous (hands-off, eyes-off) vehicle operation, even in a low-speed vehicle parking scenario, could be limited to only higher-end vehicles. Accordingly, while such conventional vehicle depth or range perception systems do work for their intended purpose, there exists an opportunity for improvement in the relevant art.

### SUMMARY

According to one example aspect of the invention, a mono camera based depth perception system for a vehicle is presented. In one exemplary implementation, the mono camera based depth perception system comprises a mono camera system configured to capture image data of an environment external to the vehicle, the environment including a set of markings that are recognizable by the mono camera system and a control system configured to determine depth from the mono camera system or the vehicle to the set of markings based on the captured image data and known parameters of the set of markings, localize a position of the vehicle within the environment based on the determined depth, and control operation of the vehicle based on its localized position within the environment.

In some implementations, the mono camera based depth perception system further comprises the set of markings, wherein the set of markings are installed in a controlled environment. In some implementations, each of the set of markings includes a Zhang calibration pattern. In some implementations, the set of markings includes first and second markings arranged on a ground plane or surface and at ends of first and second lanes for guiding the vehicle. In some implementations, the control system is configured to control the vehicle as part of an automated or autonomous parking feature. In some implementations, the controlled environment is a valet parking environment and the first and second lanes define a valet parking route or a valet parking spot for the vehicle. In some implementations, the controlled environment is a customer's garage or designated parking space and the first and second lanes define a parking spot for the vehicle.

In some implementations, the set of markings includes a third marking arranged at an intersection between the ground plane or surface and a back wall or surface of the customer's garage, and wherein the control system is configured to localize the position of the vehicle and control operation of the vehicle based further on camera image data including the third marking. In some implementations, the control system does not utilize a light detection and ranging (LIDAR) system for determining the depth, localizing the vehicle position, or controlling the vehicle. In some implementations, the control system does not utilize a radio detection and ranging (RADAR) system for determining the depth, localizing the vehicle position, or controlling the vehicle.

According to another example aspect of the invention, a mono camera based depth perception method for a vehicle is presented. In one exemplary implementation, the mono camera based depth perception method comprises providing a set of markings in an environment external to the vehicle, wherein the set of markings are recognizable by a mono camera system of the vehicle, capturing, by the mono camera system, image data of the environment including the set of markings, determining, by a control system of the vehicle, depth from the mono camera system or the vehicle to the set of markings based on the captured image data and known parameters of the set of markings, localizing, by the control system, a position of the vehicle within the environment based on the determined depth, and controlling, by the control system, operation of the vehicle based on its localized position within the environment.

In some implementations, the providing of the set of markings includes installing or affixing the set of markings in a controlled environment. In some implementations, each of the set of markings includes a Zhang calibration pattern. In some implementations, the set of markings includes first and second markings arranged on a ground plane or surface and at ends of first and second lanes for guiding the vehicle. In some implementations, the controlling of the vehicle is performed as part of an automated or autonomous parking feature. In some implementations, the controlled environment is a valet parking environment and the first and second lanes define a valet parking route or a valet parking spot for the vehicle. In some implementations, the controlled environment is a customer's garage or designated parking space and the first and second lanes define a parking spot for the vehicle.

In some implementations, the set of markings includes a third marking arranged at an intersection between the ground plane or surface and a back wall or surface of the customer's garage, and wherein the control system is configured to localize the position of the vehicle and control operation of the vehicle based further on camera image data including the third marking. In some implementations, the control system does not utilize a LIDAR system for determining the depth, localizing the vehicle position, or controlling the vehicle. In some implementations, the control system does not utilize a RADAR system for determining the depth, localizing the vehicle position, or controlling the vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example mono camera based depth perception system according to the principles of the present application;

FIGS. 2A-2B are diagrams of an example marking recognizable at various orientations or angles by a mono camera system of a vehicle according to the principles of the present application;

FIG. 3 is an overhead view of an example infrastructure including a plurality of markings that are recognizable by a mono camera system of a vehicle according to the principles of the present application; and

FIG. 4 is a flow diagram of an example mono camera based depth perception method for a vehicle according to the principles of the present application.

### DESCRIPTION

As previously discussed, fully autonomous (hands-off, eyes-off) vehicle operation, even in a low-speed vehicle parking scenario, could be limited to only higher-end vehicles having light detection and ranging (LIDAR) systems or radio detection and ranging (RADAR) systems. This is because camera-based depth perception is an estimate (not a direct measurement) and thus is typically inaccurate, particularly for mono (monocular) cameras. Accordingly, an improved infrastructure that adds recognizable markers (e.g., signs) and improved techniques that utilize these markers to precisely determine depth using only a mono camera system. In one embodiment, each marker includes a Zhang calibration pattern, for which a mono camera system can recognize both its depth and its orientation/angle relative to the mono camera system, but other markers/patterns could be utilized. For example, these markers could be installed at the ends of “lanes” between which the vehicle should park, and another marker could be installed at a barrier (e.g., a back wall/surface of a customer's garage or parking space). The primary benefit of this infrastructure and these techniques is the ability to achieve fully autonomous operation in a low-speed vehicle parking scenario without adding any additional sensors (e.g., LIDAR).

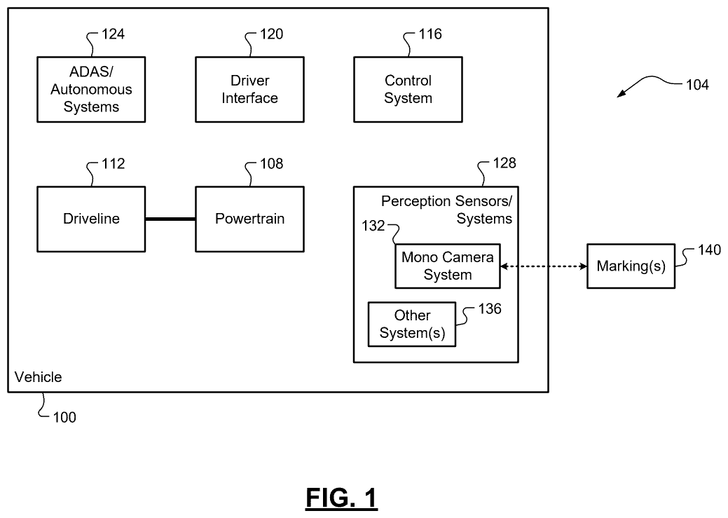

Referring now to FIG. 1, a functional block diagram of a vehicle 100 having an example mono camera based depth perception system 104 according to the principles of the present application is illustrated. The vehicle 100 generally comprises a powertrain 108 configured to generate and transfer drive torque to a driveline for propulsion. Non-limiting examples of components of the powertrain 108 include an electric motor, an internal combustion engine, a transmission, and combinations thereof. A controller or control system 116 controls operation of the vehicle 100, which primarily includes controlling the powertrain 108 to generate a sufficient amount of drive torque to satisfy a driver torque request provided by a driver of the vehicle 100 via a driver interface 120 (e.g., an accelerator pedal). The vehicle 100 also includes one or more automated driver-assistance (ADAS) or autonomous driving systems 124 that are each configured to execute one or more ADAS/autonomous driving features. Non-limiting examples of these ADAS/autonomous driving features include automated emergency braking (AEB), active cruise control (ACC), automated lane keeping/changing, and automated vehicle parking. It will be appreciated that these are merely examples of ADAS/autonomous driving features and that the infrastructure and techniques of the present application could be applicable to any ADAS/autonomous (e.g., up to L4 or L5 fully-autonomous driving) or other driving features of the vehicle 100.

The control system 116 is also configured to generate an environmental model of an environment external to the vehicle 100. This environmental model can include detected objects and their corresponding distances or ranges. The generated environmental model can then be used by the control system 116 to control various aspects of operation of the vehicle 100, such as controlling acceleration/braking/steering of the vehicle 100 as part of the ADAS/autonomous driving features (e.g., automated vehicle parking). The generation of this environmental model is performed based on data captured by various perception sensors or systems 128 of the vehicle 100. For the mono camera based depth perception techniques of the present application, the perception sensors or systems 128 include a mono (monocular) camera system 132. As previously discussed herein, the mono camera based depth perception techniques of the present application do not rely upon LIDAR or RADAR based depth or range perception as these systems, especially LIDAR systems, are very costly. Thus, the perception sensors or systems 128 likely do not include a LIDAR and/or RADAR system configured for depth or range perception, although it will be appreciated that the vehicle 100 include a LIDAR and/or RADAR system (other system(s) 136) configured for a different use. The control system 116 is also configured to perform the mono camera based depth perception techniques of the present application utilizing one or more infrastructure-based markers or markings 140, which will now be discussed in greater detail.

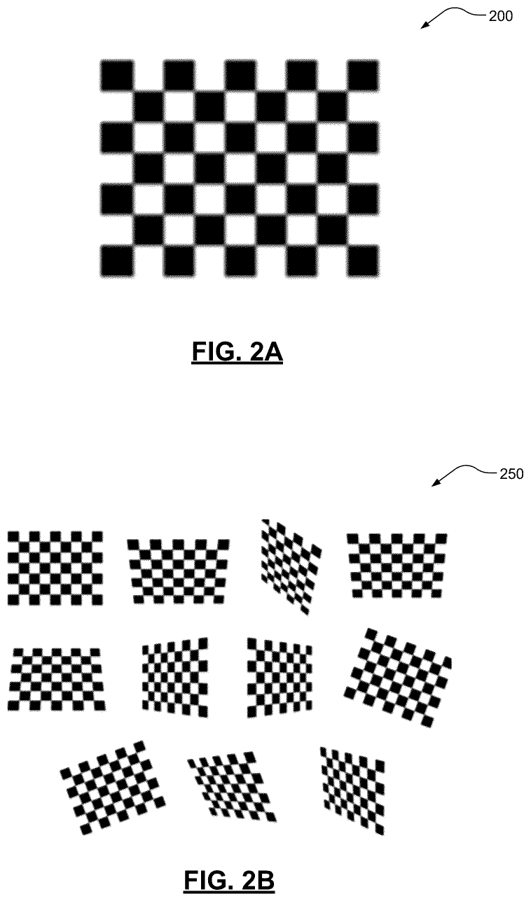

Referring now to FIGS. 2A-2B and with continued reference to FIG. 1, diagrams of an example marking 200 recognizable at different orientations or angles (see diagram 250) by a mono camera system of the vehicle are illustrated. In use, the techniques of the present application provide a safe method to offer higher levels of autonomy in controlled conditions, for example, a customer's garage or a restaurant valet parking lot, by augmenting the infrastructure with simple markers. Fixed patterns can be used to calibrate camera systems or take real measurements. FIG. 2A illustrates an example marking 200 known as the Zhang camera or calibration pattern, which is a planar pattern having known or predefined parameters. For example, the pattern could be based on a checkerboard defining one or more 2×2 grids of alternate black and white cells. The Zhang calibration pattern 200 allows for easy detection of the edges between boxes. While the Zhang calibration pattern 200 is specifically shown and described herein, it will be appreciated that other suitable calibration patterns (e.g., a Tsai camera or calibration pattern) or other objects having known or predefined sizes could be utilized to perform depth perception using only a mono camera system per the techniques of the present application.

The relative size of the boxes can very accurately determine the angle of the camera to the calibration pattern shown below via varying perspectives. As shown in the diagram 250 of FIG. 2B, depending on the orientation or angle of the Zhang calibration pattern 200 relative to the mono camera system, intrinsic parameters of the mono based camera system can be determined, which includes depth amongst other parameters (focal length, distortion coefficients, etc.). The relative size of the pattern in the camera frame directly related to the distance between the mono camera system and an object having the marking 200 attached or affixed thereto. Relative size derives depth if the original object size is accurately known and the system is well calibrated. Relative size of objects in the same field-of-view (FOV) also directly relates to depth, but in this case that relative difference is a function of the observation point and the distance between the objects. The key point is that if the object sizes and distance between objects is well knows, the observation distance can be well calibrated.

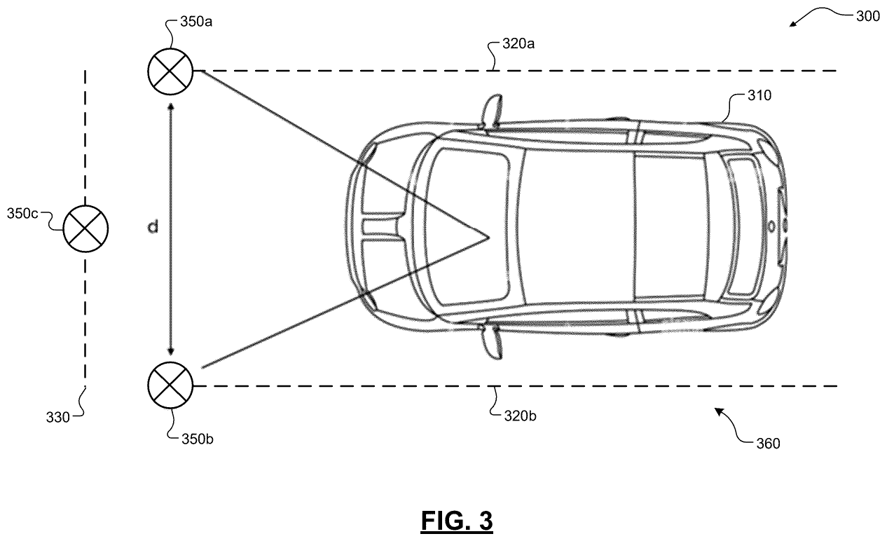

Referring now to FIG. 3 and with continued reference to the previous figures, an overhead view of an example infrastructure 300 including a plurality of markings 350a-350c (collectively, “markings 350) that are recognizable by a mono camera system of a vehicle 310 according to the principles of the present application is illustrated. If the camera depth and perspective from a fixed position can be calculated, a four by-four (4×4) matrix can be calculated between the markers at a known position or known spacing. This fixed variable fundamentally resolves the following equation:

$$[ \begin{matrix}[ \begin{matrix}{X}_{X} & {Y}_{X} & {Z}_{X} \\ {X}_{Y} & {Y}_{Y} & {Z}_{Y} \\ {X}_{Z} & {Y}_{Z} & {Z}_{Z}\end{matrix} ] & \begin{matrix}X \\ Y \\ Z\end{matrix} \\ \begin{matrix}0 & 0 & 0\end{matrix} & 1\end{matrix} ] , \qquad ( 1 )$$

where X, Y, and Z represent the known positions/spacings and the calculated positions/spacings relative to the marking(s). In practice or use, the object markings 350 can be spaced at controlled distance (d) on a ground plane 360 as shown in FIG. 3. For example, this controlled distance d could correspond to a distance between two lanes or physical lines 320a, 320b in which the vehicle 310 should park itself.

Fixing the distance d allows for accurate calculation of the vehicle-to-marker distance (i.e., depth from the vehicle 310 to the markers 350a, 350b). Locating the vehicle 310 relative to these markings 350 makes localization in a controlled environment relatively easy. Thus, expensive mapping systems associated with higher levels of autonomy and/or additional expensive depth perception systems (LIDAR, RADAR, etc.) are not necessarily required. The markers are also directly on the ground plane 360. This is also critical for correcting the flat world approximation. Distance of an unknown object from the vehicle 310 is directly related to the height of the object in the camera frame where it intersects the ground plane 360. This is called the flat world approximation and is not very accurate, that is unless the distance of the marker on the ground plane 360 can be accurately determined. This then calibrates the flat word approximation to be very accurate. A few specific use cases of automated vehicle parking will now be discussed in greater detail.

In a first use case, markings 350a, 350b could be added to a customer's garage that mark the end of the “lanes” for which the vehicle 310 should park between. A third marking 350c could also be added at the intersection 330 of a floor or the ground plane 360 with a back wall/surface of a customer's garage or, alternatively, at a curb or endpoint of a customer's designated parking space. Simple computer vision techniques can then be used for the vehicle 310 to be able to locate itself in the garage using a mono camera system only. By correcting the flat world approximation, objects, such as people, can be accurately ranged to determine collision risk level. In a second use case, markings 350a, 350b could be added in a controlled valet parking environment at the end of “lanes” in direction of travel guide the vehicle 310, again localizing the vehicle 310 and calibrating the distance of unknown objects. Furthermore, any pedestrians will know exactly where the vehicle 310 is headed similar to locomotives that have long stopping distances but highly predictable trajectories, thereby decreasing pedestrian collision probability.

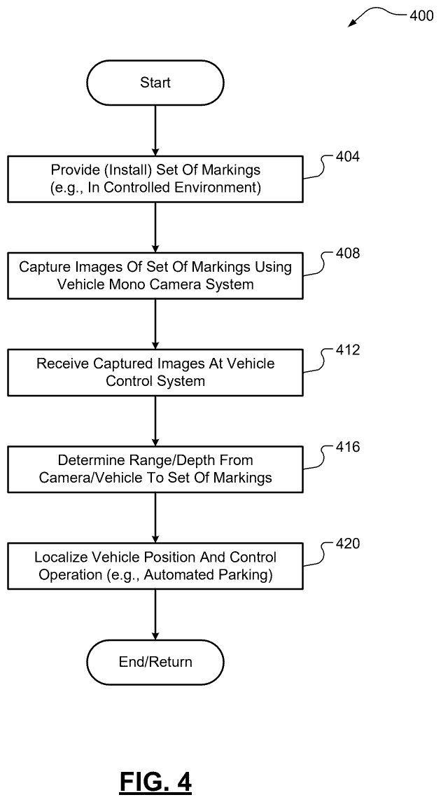

Referring now to FIG. 4 and with continued reference to the previous figures, a flow diagram of an example mono camera based depth perception method 400 for a vehicle according to the principles of the present application is illustrated. While the method 400 specifically references the vehicle 100 and its components, it will be appreciated that the method 400 could be applicable to any suitably configured vehicle. The method 400 begins at 404 where one or more markings are provided (e.g., installed or added to a controlled environment infrastructure). As previously described herein, the marking(s) could include lane markings 350a, 350b and, in some cases, a wall/surface intersection marking 350c. At 408, the mono camera system 132 captures one or more images of the marking(s). At 412, the control system 116 receives the captured images including the marking(s). At 416, the control system 116 determines a range or depth of the vehicle 100 from the marking(s). At 420, the control system 116 localizes a position of the vehicle 100 based on the determined range/depth and controls operation of the vehicle 100 accordingly. For example, this could include execution of an automated or autonomous parking feature. The method 400 then ends or returns to 404 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A mono camera based depth perception system for a vehicle, the mono camera based depth perception system comprising:
a mono camera system configured to capture image data of an environment external to the vehicle, the environment including a set of markings that are recognizable by the mono camera system; and
a control system configured to:
determine depth from the mono camera system or the vehicle to the set of markings based on the captured image data and known parameters of the set of markings;
localize a position of the vehicle within the environment based on the determined depth; and
control operation of the vehicle based on its localized position within the environment.

2. The mono camera based depth perception system of claim 1, further comprising the set of markings, wherein the set of markings are installed in a controlled environment.

3. The mono camera based depth perception system of claim 2, wherein each of the set of markings includes a Zhang calibration pattern.

4. The mono camera based depth perception system of claim 2, wherein the set of markings includes first and second markings arranged on a ground plane or surface and at ends of first and second lanes for guiding the vehicle.

5. The mono camera based depth perception system of claim 4, wherein the control system is configured to control the vehicle as part of an automated or autonomous parking feature.

6. The mono camera based depth perception system of claim 5, wherein the controlled environment is a valet parking environment and the first and second lanes define a valet parking route or a valet parking spot for the vehicle.

7. The mono camera based depth perception system of claim 5, wherein the controlled environment is a customer's garage or designated parking space and the first and second lanes define a parking spot for the vehicle.

8. The mono camera based depth perception system of claim 7, wherein the set of markings includes a third marking arranged at an intersection between the ground plane or surface and a back wall or surface of the customer's garage, and wherein the control system is configured to localize the position of the vehicle and control operation of the vehicle based further on camera image data including the third marking.

9. The mono camera based depth perception system of claim 1, wherein the control system does not utilize a light detection and ranging (LIDAR) system for determining the depth, localizing the vehicle position, or controlling the vehicle.

10. The mono camera based depth perception system of claim 1, wherein the control system does not utilize a radio detection and ranging (RADAR) system for determining the depth, localizing the vehicle position, or controlling the vehicle.

11. A mono camera based depth perception method for a vehicle, the mono camera based depth perception method comprising:
providing a set of markings in an environment external to the vehicle, wherein the set of markings are recognizable by a mono camera system of the vehicle;
capturing, by the mono camera system, image data of the environment including the set of markings;
determining, by a control system of the vehicle, depth from the mono camera system or the vehicle to the set of markings based on the captured image data and known parameters of the set of markings;
localizing, by the control system, a position of the vehicle within the environment based on the determined depth; and
controlling, by the control system, operation of the vehicle based on its localized position within the environment.

12. The mono camera based depth perception method of claim 11, wherein the providing of the set of markings includes installing or affixing the set of markings in a controlled environment.

13. The mono camera based depth perception method of claim 12, wherein each of the set of markings includes a Zhang calibration pattern.

14. The mono camera based depth perception method of claim 12, wherein the set of markings includes first and second markings arranged on a ground plane or surface and at ends of first and second lanes for guiding the vehicle.

15. The mono camera based depth perception method of claim 14, wherein the controlling of the vehicle is performed as part of an automated or autonomous parking feature.

16. The mono camera based depth perception method of claim 15, wherein the controlled environment is a valet parking environment and the first and second lanes define a valet parking route or a valet parking spot for the vehicle.

17. The mono camera based depth perception method of claim 15, wherein the controlled environment is a customer's garage or designated parking space and the first and second lanes define a parking spot for the vehicle.

18. The mono camera based depth perception method of claim 17, wherein the set of markings includes a third marking arranged at an intersection between the ground plane or surface and a back wall or surface of the customer's garage, and wherein the control system is configured to localize the position of the vehicle and control operation of the vehicle based further on camera image data including the third marking.

19. The mono camera based depth perception method of claim 11, wherein the control system does not utilize a light detection and ranging (LIDAR) system for determining the depth, localizing the vehicle position, or controlling the vehicle.

20. The mono camera based depth perception method of claim 11, wherein the control system does not utilize a radio detection and ranging (RADAR) system for determining the depth, localizing the vehicle position, or controlling the vehicle.
